(19) United States
(12) Patent Application Publication
(10) Pub. No.: US 2004/0185302 A1
(43) Pub. Date: Sep. 23, 2004

(54) Aromatic polymers with multiple side chains and methods for use thereof

(76) Inventors: Frank P. Uckert, Santa Barbara, CA (US); Howard E. Simmons III, Wilmington, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/771,040

(22) Filed: Feb. 3, 2004

Related U.S. Application Data
(60) Provisional application No. 60/446,914, filed on Feb. 12, 2003.

(51) Int. Cl. B32B 9/00

(52) U.S. Cl. 428/690

(57) ABSTRACT

Polymeric compositions are provided comprising aromatic monomeric units selected from fluorene, spirofluorene, and bridged biphenyl, wherein the polymeric composition has at least two different substituents selected from alkyl, heteroalkyl, alkenyl, heteroalkenyl, alkynyl, heteroalkynyl, aryl, heteroaryl, arylalkyl, and heteroarylalkyl. The variation of substituents alters the morphology of invention polymeric compositions relative to polymers that lack variation of substituents. When used as an active layer(s) in electroluminescent (EL) devices, the altered morphology results in EL layers with improved efficiency, which in turn results in more efficient EL devices. The polymeric compositions of the invention also have increased solubility in solvents and better film-forming properties.

### BACKGROUND OF THE INVENTION

1. Field of the Invention

This invention relates to electroluminescent aromatic polymers. The invention further relates to electronic devices in which the active layer includes such polymeric materials.

2. Description of the Related Art

Electroluminescent (EL) devices (such as light-emitting diodes) are present in many different kinds of electronic equipment. In all such devices, an electroluminescent layer is sandwiched between two electrical contact layers. At least one of the electrical contact layers is light-transmitting so that light can pass through the electrical contact layer. The electroluminescent layer emits light through the light-transmitting electrical contact layer upon application of electricity across the electrical contact layers.

Several classes of photoluminescent polymers have been used as electroluminescent layers, including poly(1,4-phenylene vinylene) and derivatives; polythiophenes, especially, poly(3-alkylthiophenes); poly(p-phenylenes), and alkyl and dialkyl derivatives of polyfluorene. Although these materials are suitable for use as electroluminescent layers, there is an increasing demand for EL devices with improved efficiency and increased operational lifetime. Accordingly, there is a concomitant need for materials which can impart improved efficiency to an EL device.

### SUMMARY OF THE INVENTION

Polymeric compositions are provided comprising aromatic monomeric units selected from fluorene, spirofluorene, and bridged biphenyl, wherein the polymeric composition has at least two different substituents selected from alkyl, heteroalkyl, alkenyl, heteroalkenyl, alkynyl, heteroalkynyl, aryl, heteroaryl, arylalkyl, and heteroarylalkyl. The variation of substituents alters the morphology of invention polymeric compositions relative to polymers that lack variation of substituents. When used as an active layer(s) in electroluminescent (EL) devices, the altered morphology results in EL layers with improved efficiency, which in turn results in more efficient EL devices. The polymeric compositions of the invention also have increased solubility in solvents and better film-forming properties.

In another embodiment, there are provided organic light emitting diodes and electroluminescent devices including active layers comprising invention compositions.

In another embodiment, there are provided methods for improving efficiency of an electroluminescent device, comprising incorporating into the active layer of the device a polymeric composition comprising aromatic monomeric units selected from fluorene, spirofluorene, and bridged biphenyl, wherein the polymeric composition has at least a first substituent and a second substituent, wherein the first substituent is different from the second substituent and both substituents are independently selected from alkyl, heteroalkyl, alkenyl, heteroalkenyl, alkynyl, heteroalkynyl, aryl, heteroaryl, arylalkyl, and heteroarylalkyl.

In another embodiment, there are provided methods for forming polymeric compositions comprising:

providing a plurality of aromatic monomers selected from fluorene, spirofluorene and bridged biphenyl;

treating the monomers with at least two reagents capable of adding substituents to the monomers, said substituents being independently selected from alkyl, heteroalkyl, alkenyl, heteroalkenyl, alkynyl, heteroalkynyl, aryl, heteroaryl, arylalkyl, and heteroarylalkyl, to form a mixture of randomly substituted monomers;

polymerizing said mixture of randomly substituted monomers to form a polymer.

As used herein, the term “active” refers to any material that exhibits electroluminescence or other electro-radiative properties.

The term “alkyl” is intended to mean a group derived from an aliphatic hydrocarbon and includes linear, branched and cyclic groups which may be unsubstituted or substituted. The term “heteroalkyl” in intended to mean an alkyl group, wherein one or more of the carbon atoms within the alkyl group has been replaced by another atom, such as nitrogen, oxygen, sulfur, and the like.

The term “alkenyl” is intended to mean a group derived from an aliphatic hydrocarbon having at least one carbon-carbon double bond, and includes linear, branched and cyclic groups which may be unsubstituted or substituted. The term “heteroalkenyl” is intended to mean an alkenyl group, wherein one or more of the carbon atoms within the alkenyl group has been replaced by another atom, such as nitrogen, oxygen, sulfur, and the like.

The term “alkynyl” is intended to mean a group derived from an aliphatic hydrocarbon having at least one carbon-carbon triple bond, and includes linear, branched and cyclic groups which may be unsubstituted or substituted. The term “heteroalkenyl” is intended to mean an alkynyl group, wherein one or more of the carbon atoms within the alkynyl group has been replaced by another atom, such as nitrogen, oxygen, sulfur, and the like.

The term “aryl” is intended to mean a group derived from an aromatic hydrocarbon which may be unsubstituted or substituted. The term “heteroaryl” in intended to mean an aryl group, wherein one or more of the carbon atoms within the aryl group has been replaced by another atom, such as nitrogen, oxygen, sulfur, and the like.

The term “arylalkyl” is intended to mean a group derived from an alkyl group having an aryl substituent. The point of attachment is on the aryl part of the group. The term “heteroarylalkyl” is intended to mean a group derived from an alkyl group having a heteraryl substituent. The point of attachment is on the heteroaryl part of the group.

The term “degree of polymerization” is intended to mean the total number of monomeric units in the polymer.

The term “monomer” is intended to mean a molecule capable of reacting with other monomers to form a polymer. The term “monomeric unit” is intended to mean the repeating unit in a polymer which results from the polymerization of the monomer.

The term “polymer” is intended to include both homopolymers, and copolymers of two or more different monomers.

The term “9-position” refers to the carbon in fluorene given the number designation 9, according to IUPAC nomenclature.

The term “spirofluorene” is intended to mean two fluorene groups joined at the 9-position.

### BRIEF DESCRIPTION OF THE FIGURE

FIG. 1 illustrates a cross-sectional view of an electronic device that includes an active layer comprising a polymeric composition according to the invention.

### DETAILED DESCRIPTION OF THE INVENTION

Invention polymeric compositions comprise aromatic monomeric units selected from fluorene, spirofluorene, and bridged biphenyl, wherein the polymeric composition has at least a first substituent and a second substituent, wherein the first substituent is different from the second substituent and both substituents are independently selected from alkyl, heteroalkyl, alkenyl, heteroalkenyl, alkynyl, heteroalkynyl, aryl, heteroaryl, arylalkyl, and heteroarylalkyl. The aromatic monomeric units result in a polymer having a predominately aromatic backbone. The two different substituents can be on the same monomeric unit. That monomeric unit can be in a homopolymer, or combined with other monomeric units in a copolymer. The two different substituents can be on different monomeric units in a copolymer. The substituents can be of the same type, e.g., both can be alkyl groups, or can be of different types, e.g., one alkyl and one aryl. Invention polymeric compositions contain at least two different substituents, and may contain as many as desired, limited only by practical synthetic considerations. The molar ratio of monomeric units having the first substituent to monomeric units having the second substituent is generally is the range of 100:1 to 1:100; preferably the molar ratio is in the range of 10:1 to 1:10. The degree of polymerization of the polymer is at least 10; preferably greater than 50; more preferably greater than 100. The degree of polymerization can be 3000, or even higher, as long as the polymer is soluble or dispersible in solvents for coating without gelling, and can be formed into a film.

Examples of suitable substituents include alkyl groups having 1-20 carbon atoms; alkoxy groups having 1-20 carbon atoms; phenyl; pyridyl; and benzyl.

In one embodiment, the polymer can be formed from a mixture of monomers, said mixture being the result of random alkylation of one or more types of monomers. For example, an unsubstituted aromatic monomer can be treated with a mixture of alkylating agents having different alkyl groups, resulting in a mixture of substituted monomers. Some substituted monomers will have two or more of the same alkyl group, some will have different alkyl groups. The mixture of substituted monomers can then be polymerized directly with isolating each monomer.

In a preferred embodiment, the aromatic units are fluorenes and the substituents are alkyl groups at the 9-position. While the invention is not limited to this embodiment, it will be illustrated by further discussion of this embodiment.

The monomeric units in the fluorene polymers can be a fluorene having two different alkyl groups in the 9-position; a first fluorene having two first alkyl groups in the 9-position and a second fluorene having two second alkyl groups in the 9-position; or combinations of two or more of each type of fluorene monomer described above. When a fluorene polymer of the invention is incorporated into an electroluminescent device as an active layer, AFM examination of the layer indicates a change in morphology throughout the layer. The resulting device has an improved device efficiency.

The alkyl substituents are selected from C₁ to about C₂₀ linear, cyclic, or branched chain alkyl moieties. In another embodiment, the alkyl moieties are selected from C₄ to about C₁₂ linear, cyclic, or branched chain alkyl moieties. In another embodiment, the alkyl moieties are selected from C₈ to about C₁₂ linear, cyclic, or branched chain alkyl moieties. The first alkyl substituent may differ from the second alkyl substituent in any way so that they are not identical. For example, they may differ in terms of the number of carbon atoms, in branching, or in linearity.

The polymeric composition of the invention may additionally comprise other monomeric units. These units may be added to alter the electronic properties of the polymer, such as charge transport or emission color; to alter the physical properties of the polymer, such as solubility; or to enhance or alter other properties of the polymer.

Invention polymeric compositions can be prepared by a variety of conventional techniques. Both Yamamoto and Suzuki polymerization can be used. In Yamamoto polymerization, monomers having Cl, Br, I, or toslyate functional groups, are added to a solution of a Ni(0) compound in an inert solvent. Typically, a nickel (0) cyclooctadiene complex is used in the presence of a 2,2′-bipyridine in a solvent such as DMF. The reaction is generally carried out at temperatures in the range of 60-80° C., and the resulting polymers isolated using known techniques, such as precipitation.

In Suzuki polymerization, monomers having boronic acid functional groups are polymerized with monomers having halide or tosylate functional groups in coupling reactions using Pd(0) catalysts. Alternatively, monomers having both types of functional groups can be used. The monomers may be commercially available, or can be prepared using known synthetic procedures. For example, monomers having bromine functional groups can be synthesized by bromination of an aromatic compound in chloroform. Monomers having boronic acid functional groups can be synthesized, for example, by reaction a bromo-aromatic compound with an organolithium reagent, then quenching the reaction with trimethylborate.

Invention compositions are soluble in common processing solvents. Thus, invention compositions can be incorporated into electroluminescent devices by solution techniques, such as spin coating, and the like.

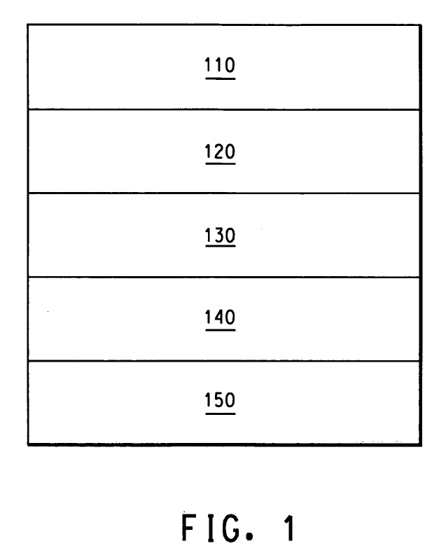

In another embodiment of the invention, there are provided electronic devices comprising at least one electroactive layer (usually a semiconductor conjugated polymer) positioned between two electrical contact layers, wherein at least one of the layers of the device includes an electroluminescent layer comprising invention compositions. As shown in FIG. 1, a typical device has an anode layer 110, a buffer layer 120, an electroluminescent layer 130, and a cathode layer 150. Adjacent to the cathode layer 150 is an optional electron-injection/transport layer 140. Between the buffer layer 120 and the cathode layer 150 (or optional electron injection/transport layer 140) is the electroluminescent layer 130.

The device may include a support or substrate (not shown) that can be adjacent to the anode layer 110 or the cathode layer 150. Most frequently, the support is adjacent the anode layer 110. The support can be flexible or rigid, organic or inorganic. Generally, glass or flexible organic films are used as a support. The anode layer 110 is an electrode that is more efficient for injecting holes compared to the cathode layer 150. The anode can include materials containing a metal, mixed metal, alloy, metal oxide or mixed oxide. Suitable materials include the mixed oxides of the Group 2 elements (i.e., Be, Mg, Ca, Sr, Ba, Ra), the Group 11 elements, the elements in Groups 4, 5, and 6, and the Group 8-10 transition elements. As used herein, group numbers corresponding to columns within the periodic table of the elements use the “New Notation” convention as seen in the CRC Handbook of Chemistry and Physics, 81^{st} Edition (2000-2001). If the anode layer 110 is to be light transmitting, mixed oxides of Groups 12, 13 and 14 elements, such as indium-tin-oxide, may be used. As used herein, the phrase “mixed oxide” refers to oxides having two or more different cations selected from the Group 2 elements or the Groups 12, 13, or 14 elements. Some non-limiting, specific examples of materials for anode layer 110 include indium-tin-oxide (“ITO”), aluminum-tin-oxide, gold, silver, copper, and nickel. The anode may also comprise an organic material such as polyaniline.

The anode layer 110 may be formed by a chemical or physical vapor deposition process or spin-cast process. Chemical vapor deposition may be performed as a plasma-enhanced chemical vapor deposition (“PECVD”) or metal organic chemical vapor deposition (“MOCVD”). Physical vapor deposition can include all forms of sputtering, including ion beam sputtering, as well as e-beam evaporation and resistance evaporation. Specific forms of physical vapor deposition include rf magnetron sputtering and inductively-coupled plasma physical vapor deposition (“IMP-PVD”). These deposition techniques are well known within the semiconductor fabrication arts.

Usually, the anode layer 110 is patterned during a lithographic operation. The pattern may vary as desired. The layers can be formed in a pattern by, for example, positioning a patterned mask or resist on the first flexible composite barrier structure prior to applying the first electrical contact layer material. Alternatively, the layers can be applied as an overall layer (also called blanket deposit) and subsequently patterned using, for example, a patterned resist layer and wet chemical or dry etching techniques. Other processes for patterning that are well known in the art can also be used. When the electronic devices are located within an array, the anode layer 110 typically is formed into substantially parallel strips having lengths that extend in substantially the same direction.

The buffer layer 120 is usually cast onto substrates using a variety of techniques well-known to those skilled in the art. Typical casting techniques include, for example, solution casting, drop casting, curtain casting, spin-coating, screen printing, inkjet printing, and the like. Alternatively, the buffer layer can be patterned using a number of such processes, such as ink jet printing.

The electroluminescent (EL) layer 130 may typically be a conjugated polymer, such as poly(paraphenylenevinylene) or polyfluorene. The particular material chosen may depend on the specific application, potentials used during operation, or other factors. The EL layer 130 containing the electroluminescent organic material can be applied from solutions by any conventional technique, including spin-coating, casting, and printing. The EL organic materials can be applied directly by vapor deposition processes, depending upon the nature of the materials. In another embodiment, an EL polymer precursor can be applied and then converted to the polymer, typically by heat or other source of external energy (e.g., visible light or UV radiation).

Optional layer 140 can function both to facilitate electron injection/transport, and can also serve as a confinement layer to prevent quenching reactions at layer interfaces. More specifically, layer 140 may promote electron mobility and reduce the likelihood of a quenching reaction if layers 130 and 150 would otherwise be in direct contact. Examples of materials for optional layer 140 include metal-chelated oxinoid compounds (e.g., Alq₃ or the like); phenanthroline-based compounds (e.g., 2,9-dimethyl-4,7-diphenyl-1,10-phenanthroline (“DDPA”), 4,7-diphenyl-1,10-phenanthroline (“DPA”), or the like); azole compounds (e.g., 2-(4-biphenylyl)-5-(4-t-butylphenyl)-1,3,4-oxadiazole (“PBD” or the like), 3-(4-biphenylyl)-4-phenyl-5-(4-t-butylphenyl)-1,2,4-triazole (“TAZ” or the like); other similar compounds; or any one or more combinations thereof. Alternatively, optional layer 140 may be inorganic and comprise BaO, LiF, Li₂O, or the like.

The cathode layer 150 is an electrode that is particularly efficient for injecting electrons or negative charge carriers. The cathode layer 150 can be any metal or nonmetal having a lower work function than the first electrical contact layer (in this case, the anode layer 110). As used herein, the term “lower work function” is intended to mean a material having a work function no greater than about 4.4 eV. As used herein, “higher work function” is intended to mean a material having a work function of at least approximately 4.4 eV.

Materials for the cathode layer can be selected from alkali metals of Group 1 (e.g., Li, Na, K, Rb, Cs,), the Group 2 metals (e.g., Mg, Ca, Ba, or the like), the Group 12 metals, the lanthanides (e.g., Ce, Sm, Eu, or the like), and the actinides (e.g., Th, U, or the like). Materials such as aluminum, indium, yttrium, and combinations thereof, may also be used. Specific non-limiting examples of materials for the cathode layer 150 include barium, lithium, cerium, cesium, europium, rubidium, yttrium, magnesium, and samarium.

The cathode layer 150 is usually formed by a chemical or physical vapor deposition process. In general, the cathode layer will be patterned, as discussed above in reference to the anode layer 110. If the device lies within an array, the cathode layer 150 may be patterned into substantially parallel strips, where the lengths of the cathode layer strips extend in substantially the same direction and substantially perpendicular to the lengths of the anode layer strips. Electronic elements called pixels are formed at the cross points (where an anode layer strip intersects a cathode layer strip when the array is seen from a plan or top view).

In other embodiments, additional layer(s) may be present within organic electronic devices. For example, a layer (not shown) between the buffer layer 120 and the EL layer 130 may facilitate positive charge transport, band-gap matching of the layers, function as a protective layer, or the like. Similarly, additional layers (not shown) between the EL layer 130 and the cathode layer 150 may facilitate negative charge transport, band-gap matching between the layers, function as a protective layer, or the like. Layers that are known in the art can be used. In addition, any of the above-described layers can be made of two or more layers. Alternatively, some or all of inorganic anode layer 110, the buffer layer 120, the EL layer 130, and cathode layer 150, may be surface treated to increase charge carrier transport efficiency. The choice of materials for each of the component layers may be determined by balancing the goals of providing a device with high device efficiency with the cost of manufacturing, manufacturing complexities, or potentially other factors.

The different layers may have any suitable thickness. Inorganic anode layer 110 is usually no greater than approximately 500 nm, for example, approximately 10-200 nm; buffer layer 120, is usually no greater than approximately 250 nm, for example, approximately 50-200 nm; EL layer 130, is usually no greater than approximately 1000 nm, for example, approximately 50-80 nm; optional layer 140 is usually no greater than approximately 100 nm, for example, approximately 20-80 nm; and cathode layer 150 is usually no greater than approximately 100 nm, for example, approximately 1-50 nm. If the anode layer 110 or the cathode layer 150 needs to transmit at least some light, the thickness of such layer may not exceed approximately 100 nm.

Depending upon the application of the electronic device, the EL layer 130 can be a light-emitting layer that is activated by signal (such as in a light-emitting diode) or a layer of material that responds to radiant energy and generates a signal with or without an applied potential (such as detectors or voltaic cells). Examples of electronic devices that may respond to radiant energy are selected from photoconductive cells, photoresistors, photoswitches, phototransistors, and phototubes, and photovoltaic cells. After reading this specification, skilled artisans will be capable of selecting material(s) that are suitable for their particular applications. The light-emitting materials may be dispersed in a matrix of another material, with or without additives, but preferably form a layer alone. The EL layer 130 generally has a thickness in the range of approximately 50-500 nm.

In organic light emitting diodes (OLEDs), electrons and holes, injected from the cathode 150 and anode 110 layers, respectively, into the EL layer 130, form negative and positively charged polarons in the polymer. These polarons migrate under the influence of the applied electric field, forming a polaron exciton with an oppositely charged species and subsequently undergoing radiative recombination. A sufficient potential difference between the anode and cathode, usually less than approximately 12 volts, and in many instances no greater than approximately 5 volts, may be applied to the device. The actual potential difference may depend on the use of the device in a larger electronic component. In many embodiments, the anode layer 110 is biased to a positive voltage and the cathode layer 150 is at substantially ground potential or zero volts during the operation of the electronic device. A battery or other power source(s) may be electrically connected to the electronic device as part of a circuit but is not illustrated in FIG. 1.

In yet another embodiment of the invention, there are provided methods for improving efficiency of an electroluminescent device, comprising incorporating into the active layer of the device a polymeric composition comprising at least two 9,9-dialkyl-fluorene monomeric units, wherein the 9,9-alkyl moieties are the same within each monomeric unit, and wherein the 9,9-alkyl moieties are independently selected between the monomeric units.

The invention will now be described in greater detail by reference to the following non-limiting examples.

### EXAMPLES

### Example 1

In this Example, the synthesis, morphology, and performance properties of an invention fluorene polymeric composition, Polymer 1 below, are described.

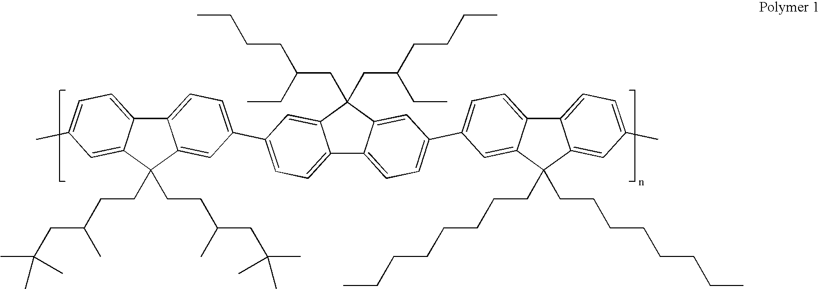

The synthesis of exemplary invention composition Polymer 1 was performed as follows. Under inert conditions, dimethylformamide (DMF, 7 ml) was added to a Schlenck tube equipped with a stirring bar and containing bis(1,5-cyclooctadiene)nickel(0) (3.33 g, 12.12 mmol), 2,2′-bipyridyl (1.89 g, 12.12 mmol), and 1,5-cyclooctadiene (1.31 g, 12.12 mmol). The ensuing deep blue/purple solution was stirred at 60° C. for 30 minutes, and then a solution of a first 9,9-dialkyl-monmeric unit, 2,7-dibromo-9,9-bis-(2-ethyl-hexyl)-9H-fluorene (1.10 g, 2.00 mmol), a second 9,9-dialkyl-monomeric unit, 2,7-dibromo-9,9-bis-(3,5,5-trimethyl-hexyl)-9H-fluorene (1.15 g, 2.00 mmol) and a third 9,9-dialkyl-monomeric unit, 2,7-dibromo-9,9-dioctyl-9H-fluorene (1.10 g, 2.00 mmol) in toluene (28 ml) was added via syringe. The reaction mixture was then stirred at 75° C. for 24 h. The mixture was cooled to room temperature and precipitated into a solution of methanol (100 ml), acetone (100 ml) and concentrated hydrochloric acid (5 ml). The mixture was stirred for two hours before filtering. The solid residue was then dissolved in chloroform, and again precipitated into a solution of methanol (100 ml), acetone (100 ml) and concentrated hydrochloric acid (5 ml). The mixture was stirred for 1 hour before filtering. The solid was again dissolved in chloroform and precipitated in pure methanol. Finally the residue was successively washed with methanol, water and methanol and then dried in vacuo.

The surface of a 1 micron square section of a film of Polymer 1 was examined with an Atomic Force Microscope (AFM). The surface morphology was dense and very smooth.

### Comparative Example A

Comparative Polymer A, having the structure below with only one type of alkyl substituent at the 9-position, was prepared using the procedure of Example 1.

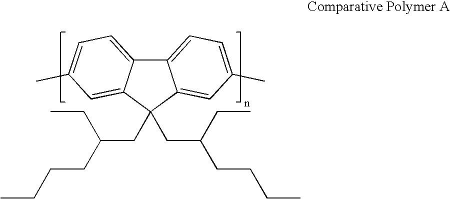

The surface of a 1 micron square section of a film of Comparative Polymer A was examined by AFM. The surface morphology was much more rough and less dense than that of Polymer 1.

### Example 2

This example illustrates the preparation of a mixture of fluorene monomers having different alkyl substituents at the 9-position, as summarized in the diagram below.

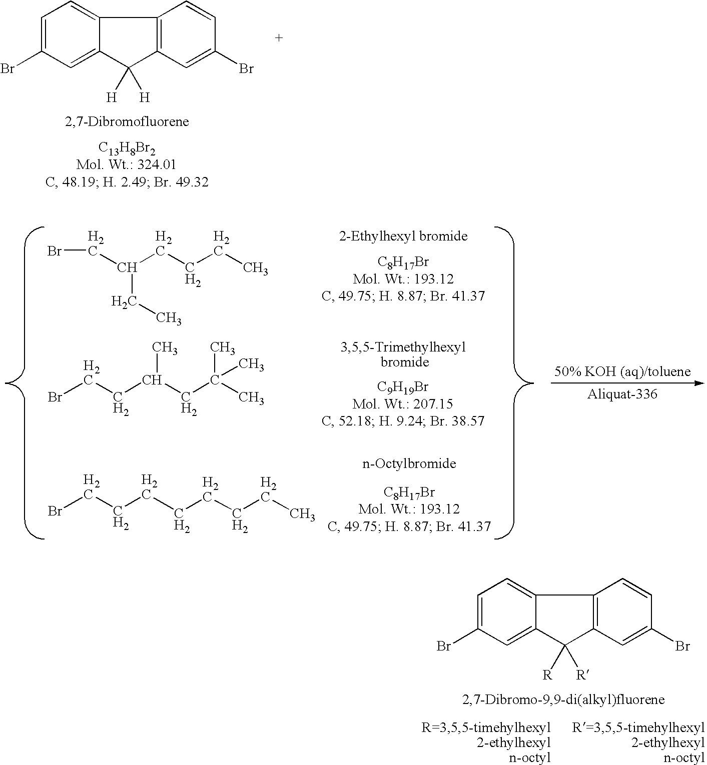

To a 250 ml, 4-necked round-bottomed flask equipped with a magnetic stirrer, thermowell, condenser, pressure-equalizing dropping funnel and N₂ inlet/outlet was added 60 ml of a freshly prepared aqueous 50 wt % potassium hydroxide solution and 60 ml toluene. 16.20 g [50 mmol] of 2,7-Dibromofluorene was added with stirring followed by the addition of ˜0.6 ml of Aliquat-336. Reaction mixture turned dark red-orange with the addition of the Aliquat 336. Reaction mixture heated to 85° C. in an oil bath.

An alkyl bromide mixture consisting of 9.66 g (50 mmol) 2-ethylhexyl bromide, 9.66 g (50 mmol) n-octyl bromide and 10.36 g (50 mmol) 3,5,5-trimethylhexylbromide added dropwise. Reaction mixture turned dark purple during alkyl bromide addition. Reaction stirred at 85° C. overnight.

The reaction was allowed to cool to room temperature and the organic phase removed. The aqueous phase was extracted with dichloromethane; 3×200 ml. The combined organic phases were extracted with 200 ml H₂O, dried over MgSO₄, filtered and the solvents removed under vacuum.

The product was then purified by Kugelrohr distillation followed by passage through a silica column using hexanes as the eluant. The hexane solution was evaporated then further dried under vacuum.

### Example 3

In this example, Polymer 2, a polymeric composition of the invention, was prepared by the polymerization of the monomer mixture from Example 2.

In a dry-box under a nitrogen atmosphere, a solution of 2,2′-bipyridyl (1.262 g, 8.08 mmol) and 1,5-cyclooctadiene (0.874 g, 8.08 mmol) in anhydrous DMF (14.0 ml) was added to an oven-dried Schlenk tube, equipped with a magnetic stirring bar, and containing bis(1,5-cyclooctadiene)nickel(0) (2.223 g, 8.08 mmol. The ensuing deep blue/purple solution was stirred at 60° C. for 30 minutes. A solution of the monomers from Example 2, 2,7-dibromo-9-(alkyl)-9-(alkyl)-9H-fluorene (2.23 g, 4.00 mmol) in anhydrous toluene (56 ml) was added via syringe. The reaction mixture was then stirred at 75° C. for 24 h. The reaction was ‘end-capped’ by the addition of chlorobenzene (3 ml).

The mixture was cooled to room temperature and precipitated into ˜500 ml of a methanol/acetone solution 50/50 (v/v) containing 50 ml concentrated hydrochloric acid.

After stirring for 1 hour, the mixture was filtered. The solid filtercake was then dissolved in chloroform (100 ml), and precipitated into ˜500 ml of a methanol/acetone solution (50/50 by volume) containing 50 ml concentrated hydrochloric acid. After stirring for 1 hour, the mixture was filtered. The solid filtercake was then dissolved in chloroform (100 ml), and precipitated into ˜500 ml of a methanol/acetone solution (50/50 (by volume). After stirring for 1 hour, the mixture was filtered. The filtercake was washed with methanol/acetone 50/50 (v/v) and dried in vacuo.

### Example 4

This example illustrates the performance of the invention polymers in a device.

Light-emitting diodes were fabricated using Polymer 1 and Comparative Polymer A as electroluminescent polymers (ELP). The devices had the architecture:

ITO/PEDOT/ELP/Ba/Al

On top of ITO, a thin layer (nominally 200 nm) of PEDOT was spin-coated and used as the buffer and the hole-injecting layer. Thickness of the EL polymer layer was approximately 60-80 nm. The thickness was measured using a surface profiler (Alpha-Step 500™ Surface Profiler, Tencor Instruments available from KLA-Tencor Corporation of San Jose, Calif.). The metal cathode film was fabricated on top of the EL polymer layer using vacuum vapor deposition at pressures below 1×10⁻⁶ Torr. The cathode area defined the active area of the devices. The deposition speed and the thickness of the cathode layer were monitored with an STM-100 thickness/rate meter (Sycon Instruments, Inc. of Syracuse, N.Y.). Immediately after deposition of barium, 500 nm of aluminum capping layer was deposited on the top of barium metal layer. Finally, the device was packaged using a simple glass cover fixed with an ultraviolet (UV) curing epoxy resin. The results for each of the devices is given in Table 1 below.

TABLE 1

| | V | MA/cm² | cd/m² | cd/A | QE (%) |
|---|---|---|---|---|---|
| Comparative | 7.5 | 33.3 | 17 | 0.05 | 0.07 |
| Polymer A | | | | | |
| Polymer 1 | 7.6 | 33.3 | 218 | 0.65 | 0.26 |
| Polymer 2 | 9.7 | 33.3 | 220 | 0.67 | |

While the invention has been described in detail with reference to certain preferred embodiments thereof, it will be understood that modifications and variations are within the spirit and scope of that which is described and claimed.

What is claimed is:

1. A polymeric composition comprising aromatic monomeric units selected from fluorene, spirofluorene, and bridged biphenyl, wherein the polymeric composition has at least a first substituent and a second substituent, wherein the first substituent is different from the second substituent and both substituents are independently selected from alkyl, heteroalkyl, alkenyl, heteroalkenyl, alkynyl, heteroalkynyl, aryl, heteroaryl, arylalkyl, and heteroarylalkyl.

2. The polymeric composition of claim 1, wherein the first substituent and the second substituent are on the same monomeric unit.

3. The polymeric composition of claim 1, wherein the first substituent and the second substituent are on different monomeric units.

4. The polymeric composition of claim 1, wherein the first substituent and the second substituent are independently selected from alkyl groups having 1-20 carbons.

5. The polymeric composition of claim 1, wherein the molar ratio of the monomeric units having the first alkyl substituent to monomeric units having the second alkyl substituent is in the range of 1:100 to 1:10.

6. The polymeric composition of claim 8, wherein the molar ratio is in the range of 1:10 to 10:1.

7. The polymeric composition of claim 1 wherein the aromatic monomeric unit is fluorene.

8. The polymeric composition of claim 5 wherein the first substituent and second substituent are in the 9-position.

9. The polymeric composition of claim 6, wherein the alkyl moieties are selected from C₁ to about C₂₀ linear alkyl moieties, C₁ to about C₂₀ cyclic alkyl moieties, and C₁ to about C₂₀ branched chain alkyl moieties.

10. The polymeric composition of claim 7, wherein the alkyl moieties are selected from C₄ to about C₁₂ linear alkyl moieties, C₄ to about C₁₂ cyclic alkyl moieties, and C₄ to about C₁₂ branched chain alkyl moieties.

11. An organic light emitting diode (OLED) comprising an active layer comprising the polymeric composition of claim 1.

12. An electroluminescent device comprising an active layer comprising the polymeric composition of claim 1.

13. A method for improving the efficiency of an electroluminescent device, comprising incorporating into the active layer of the device a polymeric composition comprising aromatic monomeric units selected from fluorene, spirofluorene, and bridged biphenyl, wherein the polymeric composition has at least a first substituent and a second substituent, wherein the first substituent is different from the second substituent and both substituents are independently selected from alkyl, heteroalkyl, alkenyl, heteroalkenyl, alkynyl, heteroalkynyl, aryl, heteroaryl, arylalkyl, and heteroarylalkyl.

14. A method for forming a polymeric composition comprising
providing a plurality of aromatic monomers selected from fluorene, spirofluorene and bridged biphenyl;
treating the monomers with at least two reagents capable of adding substituents to the monomers, said substituents being independently selected from alkyl, heteroalkyl, alkenyl, heteroalkenyl, alkynyl, heteroalkynyl, aryl, heteroaryl, arylalkyl, and heteroarylalkyl, to form a mixture of randomly substituted monomers;
polymerizing said mixture of randomly substituted monomers to form a polymer.

15. A polymeric composition comprising aromatic monomeric units selected from fluorene, spirofluorene, and bridged biphenyl, wherein the polymeric composition has at least a first substituent and a second substituent, wherein the first substituent is different from the second substituent and both substituents are independently selected from alkyl, heteroalkyl, alkenyl, heteroalkenyl, alkynyl, heteroalkynyl, aryl, heteroaryl, arylalkyl, and heteroarylalkyl.

16. A method for improving the efficiency of an electroluminescent device, comprising incorporating into the active layer of the device a polymeric composition comprising aromatic monomeric units selected from fluorene, spirofluorene, and bridged biphenyl, wherein the polymeric composition has at least a first substituent and a second substituent, wherein the first substituent is different from the second substituent and both substituents are independently selected from alkyl, heteroalkyl, alkenyl, heteroalkenyl, alkynyl, heteroalkynyl, aryl, heteroaryl, arylalkyl, and heteroarylalkyl.

17. A method for forming a polymeric composition comprising
providing a plurality of aromatic monomers selected from fluorene, spirofluorene and bridged biphenyl;
treating the monomers with at least two reagents capable of adding substituents to the monomers, said substituents being independently selected from alkyl, heteroalkyl, alkenyl, heteroalkenyl, alkynyl, heteroalkynyl, aryl, heteroaryl, arylalkyl, and heteroarylalkyl, to form a mixture of randomly substituted monomers;
polymerizing said mixture of randomly substituted monomers to form a polymer.
